(19) United States
(12) Patent Application Publication
(10) Pub. No.: US 2004/0122726 A1
(43) Pub. Date: Jun. 24, 2004

(54) Method and computer system for evaluating sales performance

(75) Inventors: Mats Linde, Vastra Frolunda (SE); Viveka Linde, Vastra Frolunda (SE)

Correspondence Address: BAKER & BOTTS, 30 ROCKEFELLER PLAZA, NEW YORK, NY, 10112

(73) Assignee: Albihns Goteborg AB, Vastervik (SE)

(21) Appl. No.: 10/328,656

(22) Filed: Dec. 23, 2002

(51) Int. Cl. G06F 17/60

(52) U.S. Cl. 705/10

(57) ABSTRACT

The present invention relates to a method for evaluating the sales performance regarding at least one first product. The method comprises: storing, in a central database, data related to the identities of a plurality of marketing representatives being associated with said product; storing, in said database, collected data related to at least one key success factor associated with the market performance related to said product as a result of marketing activities of said plurality of marketing representatives with respect to a number of customers of said product; and transmitting and presenting said information to at least one external user. The invention allows improved monitoring and evaluation of the effectiveness of a marketing or sales staff of a company.

### TECHNICAL FIELD

The invention relates to a method for evaluating sales performance regarding a product.

The invention also relates to a computer system for evaluating sales performance regarding said product.

The invention also relates to a method for facilitating and improving marketing activities and increasing sales of a product by evaluating the sales performance of a plurality of marketing representatives of a company associated with said product.

### BACKGROUND OF THE INVENTION

In many fields of trade and industry, there is a general need for systems and methods for monitoring and evaluating the performance of a product or a service on a market. In this manner, information as regards market trends, marketing impact and competition can be used. By using such information in a suitable manner, the sale of the product or service in question can be expected to be improved.

One such field of trade is the medical industry, in which there is a need to monitor and evaluate the marketing situation and market performance of various medical drugs related to different diseases. As suggested above, the obtained information can then be used to improve the sales of the drugs in question.

To a great extent, the market for drugs is constituted by physicians issuing prescriptions of drugs to patients. This means that a high degree of marketing efforts and advertising are invested in a manner so as to influence the physicians to adopt, select and prescribe a particular brand of a drug. Such marketing efforts are often implemented by a sales organization of the medical company involved, i.e., by pharmaceutical representatives which carry out various types of marketing efforts, for example meetings with physicians, seminars, group activities, etc.

The process in which a physician gradually obtains an interest for a drug—from an initial stage in which the physician becomes aware of the drug until a final stage in which the particular drug has become the physician's first rated drug, or “drug of choice”—can be referred to as the “adoption” of the drug in question. Consequently, in order to accomplish a high marketshare for a particular drug, it is of importance to obtain a situation in which the physicians who are treating patients with a particular disease “adopts” and consequently acquires an interest and confidence for the drug. If a physician has fully “adopted” a particular drug, it can be expected that the sales of that drug will be improved.

In order to obtain accurate information regarding the marketing situation related to a drug (or, in fact, any other product), it is of importance to provide means for collecting, transmitting and presenting data related to, for example, the adoption of the drug, for quick and easy understanding and treatment of such data by the respective end user. In particular, it is known that a significant part of a brand's marketshare is constituted by so-called repeat sales, i.e., the case in which a customer repeatedly purchases the same brand, while changes in the total market and/or a brand's share of the market might emanate from consumers entering or leaving the market or switching between brands.

Furthermore, it is desirable for medical companies to monitor and evaluate the effectiveness of its marketing efforts. This is particularly important since the cost for marketing (i.e., in relation to the total costs for a medical company) is substantial. For example, it can be expected that the marketing expenses of a medical company is approximately 30-40% of its total expenses. In contrast to this, the actual manufacturing cost of the drug in question is approximately 5-10% of the total expenses for a medical company. This makes it highly desirable to obtain information regarding the sales and marketing efforts of the company.

### SUMMARY OF THE INVENTION

A primary object of the invention is to provide a method and a system for providing an improved way of evaluating the performance of a sales organization, in particular as regards a medical company.

This object is accomplished by means of a method according to subsequent claim 1, i.e., a method for evaluating sales performance regarding at least one first product, comprising: storing, in a central database, data related to the identities of a plurality of marketing representatives being associated with said product; storing, in said database, collected data related to at least one key success factor associated with the market performance related to said product as a result of marketing activities of said plurality of marketing representatives with respect to a number of customers of said product; and transmitting and presenting said information to at least one external user.

This object is also accomplished by means of a computer system according to subsequent claim 5, i.e., a computer system for evaluating sales performance regarding at least one first product, comprising a database for storing collected data related to the identities of a plurality of marketing representatives being associated with said product and for storing collected data related to at least one key success factor associated with the market performance related to said product as a result of marketing activities of said plurality of marketing representatives with respect to a number of customers of said product; and a central computer unit adapted for transmitting and said information to at least one external user.

A further object of the invention is to provide a method for allowing improved marketing activities and thereby increasing sales of a product through computerized processing and presenting of information related to the performance of said sales organization.

This object is accomplished by means of a method according to subsequent claim 8, i.e., a method for facilitating and improving marketing activities and increasing sales of at least one first product by evaluating the sales performance of a plurality of marketing representatives of a company associated with said product, comprising: collecting and storing data related to the identities of said marketing representatives; collecting and storing data related to at least one key success factor associated with the market performance related to said product as a result of marketing activities of said plurality of marketing representatives with respect to a number of customers of said product; and making said information available to at least one external user.

A further object of the invention is to provide a computer-readable data carrier adapted for storing information related to the performance of a sales organization.

This object is accomplished by means of a computer-readable data carrier according to subsequent claim 12, i.e., a data carrier for storing information related to the evaluation of the sales performance of a plurality of marketing representatives of a company associated with at least one first product, said information being related to the identities of said marketing representatives and to at least one key success factor associated with the market performance related to said product as a result of marketing activities of said plurality of marketing representatives with respect to a number of customers of said product.

By means of the invention, a number of advantages will be obtained. In particular, it can be noted that the efficiency of a sales organization can be controlled and evaluated. A detailed assessment of market performance can be carried out, which can improve the sales and marketing organization. Furthermore, individual sales representatives can be given feedback on their performance and on how the customers of the product in question perceive the communicated messages.

A number of key “success factors,” which will be described below, are used. These key success factors provide transparency of a market for fast understanding, benchmarking, forecasting and strategic decision-making and are crucial for the expected future sales of the product in question.

A comprehensive and unique combination of relevant qualitative and quantitative information can be summarized as said key success factors. This provides timesaving access to and understanding of complicated market mechanisms, and allows for benchmarking versus competitors, across countries, across markets (e.g., indications) and over time.

In particular, the invention uses a measure of the so-called adoption of a particular product to be provided, as well as a measure reflecting its present market performance (ability to capture marketshares from competitors) and generate repeat businesses. The invention also provides information as to the impact of detailing.

### BRIEF DESCRIPTION OF THE DRAWINGS

The invention will now be described in more detail for explanatory, and in no sense limiting, purposes, with reference to the figures described hereafter.

FIG. 1 shows schematically how the total market for a product such as a medical drug is divided into different submarkets,

FIG. 2 shows in a simplified form a basic computer-based system in accordance with the invention,

FIG. 3 shows a geographic region having a number of associated marketing representative;

FIG. 4 shows the manner in which information related to the marketing performance can be displayed;

FIG. 5 also shows how marketing performance can be displayed;

FIG. 6 indicates the relationship between the detailing rate and capture rate, which can be used for displaying information related to the performance of a sales organization;

FIG. 7 indicates the relationship between the detailing rate and the number of visits made by a representative; and

FIG. 8 indicates the relationship between the capture rate and the number of visits made by a representative.

### DETAILED DESCRIPTION

The invention relates to a method and a system for evaluating a group of representatives, in particular for providing information related to the effectiveness and performance of said group of representatives as regards various marketing activities. As will be described in detail below, the invention is particularly, but not exclusively, adapted for processing and presenting information related to representatives involved in marketing activities in the field of medical drugs. However, the invention is equally well suited for any other product or service. In this regard, the term “product” which is used in this application is consequently used to indicate any form of article, goods, services or product which can be commercially available on a market.

Consequently, any form of business, in the form of a manufacturer, research center, marketing agency, department store or similar enterprise, may use the invention in a suitable manner in order to obtain information related to the performance or efficiency of a staff of marketing or sales-related representatives. In this manner, the invention can be used in order to meet certain desired business objectives including incremental sales and obtaining increased market shares for the product.

Furthermore, the invention can also be used in order to meet certain objectives as regards the manner in which the information related to said group of sales representatives is gathered, stored, transmitted and presented. The hardware and software components used for the invention comprises software components executing on various hardware machines. This will be described in greater detail below.

For the purpose of understanding the present invention, a number of key “success factors” for obtaining improved market performance of a product, such as a medical drug, will now be described. Such key success factors are crucial for the expected future sales of the product in question, and also for the possibilities of processing, presenting and transmitting relevant information regarding the market situation of a drug. This set of information is normally provided by a service provider such as a medical marketing company, and is supplied to a client which normally is in the form of a medical company, a drug manufacturer, a research center or a similar enterprise.

It can be noted that the key success factors provide transparency of a market for fast understanding, benchmarking, forecasting and strategic decision-making. By means of the key success factors, the structure, dynamics and trends on a particular market for a particular drug and/or disease can be studied and analyzed. The result of such a process can then easily be stored for subsequent transmission to a client.

Five key success factors will now be presented. In this regard, reference is made to the co-pending, U.S. Published Patent Application No. 2002/0184072, the contents of which are hereby incorporated by reference.

One such key success factor is the so-called “detailing rate” of a particular drug. The detailing rate is a measure or parameter which corresponds to the proportion of physicians (from a group) spontaneously recalling detailing activities related to a drug. Such detailing activities may for example consist of personal promotion from, for example, a pharmaceutical representative during a group meeting, a one-to-one meeting (i.e., a personal visit), a symposium, a seminar or a similar detailing activity. The detailing rate is assessed for a particular time period, for example the last 6 months. However, other time periods than 6 months can also be selected.

Consequently, the detailing rate provides input information related to the marketing of a particular drug, and is obtained through interviews with physicians.

In order to be successful in marketing, it is important to reach out to a sufficiently high proportion of physicians with detailing. Consequently, it is desired to obtain a high detailing rate for a particular drug.

Another key success factor is the so-called “adoption rate,” which is a measure which indicates how well a drug is adopted by a physician. The adoption rate consequently provides a measure the amount of which indicates to what degree a physician gradually adopts the drug, from a first stage with an initial first knowledge of the drug until a final stage, in which the drug constitutes the first choice (against a particular disease) for the physician. Consequently, the adoption rate provides important knowledge of the physician's emotional process during the adoption process of a drug and can be used for initiating various marketing activities. In particular, it provides a method by means of which the market adoption of different brands can be quickly and easily compared.

A further key success factor is the so-called “capture rate,” which is a measure which indicates and summarizes the present market performance of a drug. The capture rate reflects the total ability of a product to capture market shares, reflecting the impact from market and marketing influences and forecasting changes in future sales. Consequently, it can be said that the capture rate of a drug is an indication of the competitive strength of the drug, or the drug's present market performance.

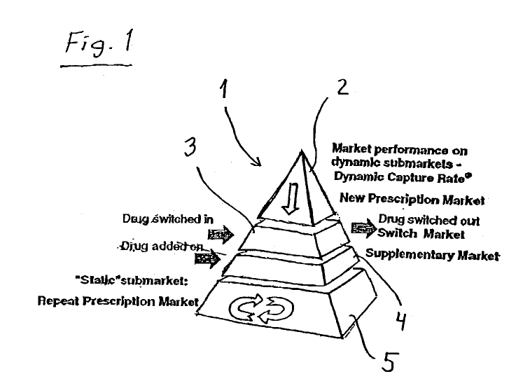

In order to fully describe the capture rate of a drug, the concept of dynamic and static market segments will now be described with reference to FIG. 1. The total market for a particular product—which is indicated by reference numeral 1 in FIG. 1—can be schematically described as a pyramid, which in turn is sub-divided into several segments. More precisely, the total market 1 can be subdivided into so-called dynamic and static market segments. In this regard, the term “dynamic submarkets” is used to describe the segments which actively change in response to external market influences. An example of such a dynamic submarket is the “new prescription market” 2, which illustrates which brands are used for the initial treatment of patients, and their relative market positions.

Another kind of dynamic submarket is the “switch market” 3, which shows brands of drugs switched in and switched out when a physician changes the prescribed drug during the treatment of an disease. A further type is the “supplementary market” 4, which illustrates which brands of drugs are added on to basic therapy.

In contrast to the dynamic markets, the so-called “repeat prescription market” 5 is a static market which is relatively stagnant and merely reflect (or result from) previous changes on the dynamic submarkets (although repeat sales often account for the bulk of total sales). The repeat prescription market 5 shows which brands are repeat prescribed. The repeat prescription market 5 is not static in the long run, but changes on this market are only the result of the dynamics on the new prescription market 2, the switch market 3 and the supplementary market 4. The results of previous marketing efforts are accumulated on the repeat prescription market 5 and it is on this market that the large prescription/sales volumes are acquired for chronic disorders.

In all chronic disorders a large part of sales emanate from repeat prescriptions—which is a consequence of yesterday's marketing efforts—and may thus camouflage what is happening in the dynamic market segments. It can be noted that a good position on the repeat prescription market 5 is often the result of a good position on the new prescription market 2. Also, losing on the switch market 3 may be the first sign of losing future repeat prescription market 5 shares.

The aim of marketing is to influence and increase the prescription rate of a drug, i.e., which leads to sales. As such, marketing needs to influence market performance by affecting the ability of the drug in question to capture new patients in the dynamics segments (i.e., the new prescription, switch and supplementary markets). This ability reflects the impact of market and marketing influences and forecasts changes in future sales on the repeat prescription market. Information about the dynamic market shares of all brands of drugs on the market, and overall market performance, are summarized by the above-mentioned capture rate.

It can be noted that the term capture rate provides a measure of the drug's present market performance. Due to the connection between what is going on in the dynamic markets and repeat prescriptions, an estimation of future sales (i.e., mostly repeat prescription sales) of the product in question can be provided.

Another key success factor is the so-called “marketing productivity” of a particular drug. This factor can be defined as the difference or marginal effect detailing has achieved in terms of the adoption and capture rate of an agent among physicians who have been detailed and those who have not been detailed during a given time period. The market productivity is presented as the impact of detailing on the adoption process and market performance of an agent.

A further key success factor relates to the rationales for brand choice, i.e., the reasons behind the choice of the physicians for selecting a particular brand of a drug. It is believed that success in the market can be obtained via the rationale for choosing a particular drug, i.e., the “why,” “when,” “to whom” and “how” of prescribing the drug. Reasons for prescriptions can be presented as verbatims and the actual market entries as market shares on the “dynamic” market segments—the new prescription market 2, the switch market 3 and the supplementary market 4.

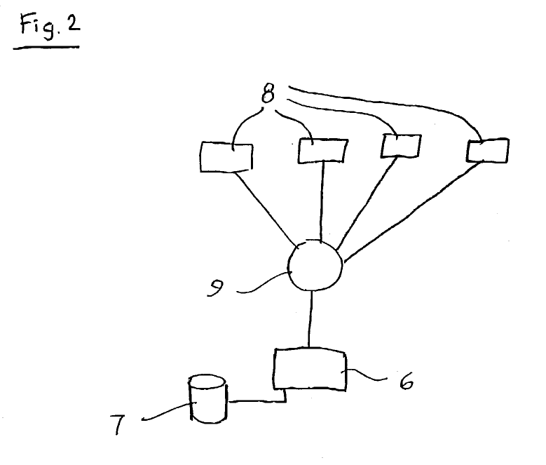

FIG. 2 indicates in a simplified and schematic manner a basic computer-based system by means of which the invention can be carried out. Said system comprises a central computer unit 6 which can be of general-purpose type, provided with a central processing unit, a memory unit, a display screen, a keyboard, a communication unit etc.

The central computer unit 6 is associated with a database 7 adapted for storing data related to the identities of a plurality of marketing representatives which are involved in marketing activities for a particular brand of a drug, and also for storing data related to the various key success factors which have been described above. As will be described below, the database is also adapted for storing information relating to the performance of said marketing representatives. The computer unit 6 is also adapted for communicating with a plurality of external computers 8 via a suitable computer network 9, such as the Internet. It is obvious that the number of external computers 8 can be very large. In this regard, each external computer 8 is associated with an external client or user who is given authority to access the information in the database 7. According to what is known as such, any one of the external computers 8 can be arranged so as to communicate with the central computer unit 6 if an appropriate user identification code and password are entered and transmitted to the central computer 6.

As mentioned, the plurality of external computers 8 corresponds to various clients or users which are cooperating with a service provider which is associated with and responsible for the central computer unit 6 with its database 7. The client can be expected to be interested in acquiring information related to the efficiency of its own marketing representatives. This will be now described in detail below. In particular, the invention will be described in detail in terms of how information related to the group of marketing representatives and the various key success factors is collected, stored, processed and presented.

Data is gathered both by interviewing chosen physicians from a target group, and by monitoring their drug prescription and purchase patterns. For example, by conducting interviews with physicians, the detailing rate can be established. More precisely, a sample of decision makers' perceived detailing about drugs of various brands on the market is used as an estimate of actual detailing rates.

Furthermore, the adoption of a drug can be graphically illustrated as a linear process which starts with the brand being a considered alternative in a physician's choice process and which ends with it becoming a “drug of choice,” or a first rated drug for a particular disease.

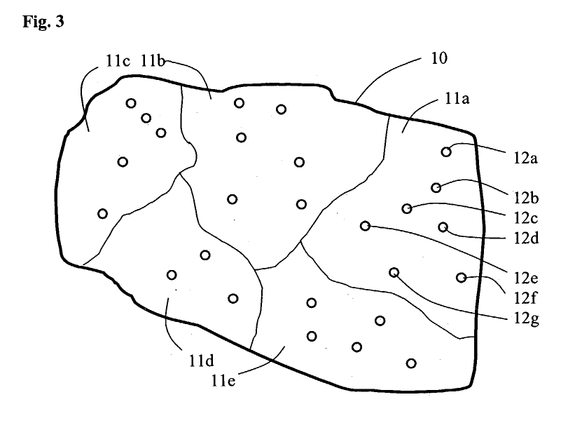

With reference to FIG. 3, a geographical area 10 such as a country or a region is indicated. The geographical area 10 can be divided into sub-regions 11a, 11b, 11c, 11d and 11e.

In the geographical area 10, a number of sales or marketing representatives 12a, 12b, . . . 12g are located. The term sales representative, as used the context of the present application, refers to a person involved in various marketing activities for a company. For example, a company developing, manufacturing and selling medical drugs, or a related company, can be described when explaining the features of the invention. In the following, the general term “representative” is used to describe such marketing persons.

Each of the representatives 12 shown in FIG. 3 is assigned to the task of marketing a particular medical drug. Such marketing is normally carried out by means of personal promotion from the representative to one or several physicians, which consequently form a target group. These physicians are located in the area for which the representative 12 is responsible. The promotion may consist of personal visits to each physician, group meetings, a symposium, a seminar or a similar activity. The target group for the representative 12 normally consists of a number of physicians, psychiatrists or similar persons, i.e., persons involved in the prescription of drugs to patients. It can be expected that each representative 3 is involved in marketing activities which are normally directed to a target group consisting of approximately 200-300 physicians. However, the invention is not limited to any particular size of such a target group.

Due to the fact that the representatives 12 are employed by a medical company it may be desirable for the company to assess the effectiveness of its representatives, especially those detailing physicians or physiatrists and about whom it is difficult to acquire information from usual sources.

For each of the representatives 12 shown in FIG. 3, certain pieces of information is gathered. In this regard, it is assumed that the information is related to a particular brand of a drug, i.e., the drug which each representative is marketing. Said information is gathered by a service provider such as a medical marketing company, and is supplied to a client which normally is in the form of a medical company or a similar company. Also, said information is gathered by carrying out interviews with the physicians involved and in order to provide measurements of the detailing rate and the capture rate for each representative 12.

Firstly, it can be noted that for each representative 12, the detailing rate as regards the drug in question is determined. This means that the proportion of physicians from the target group which spontaneously recalls the representative's 12 detailing activities is determined. For each one of the representatives, this proportion is determined and stored in the central computer unit 6 as a value.

Furthermore, for each representative 12, the capture rate as regards the drug in question is determined. This means that the present market performance of the drug, reflecting the ability of the drug to capture market shares, is determined. This corresponds to a measure of the present market performance of the drug to capture market shares on dynamic submarkets (as mentioned above), i.e., new, switch and supplementary markets, and reflecting the impact from market and marketing influences and forecasting changes in future sales.

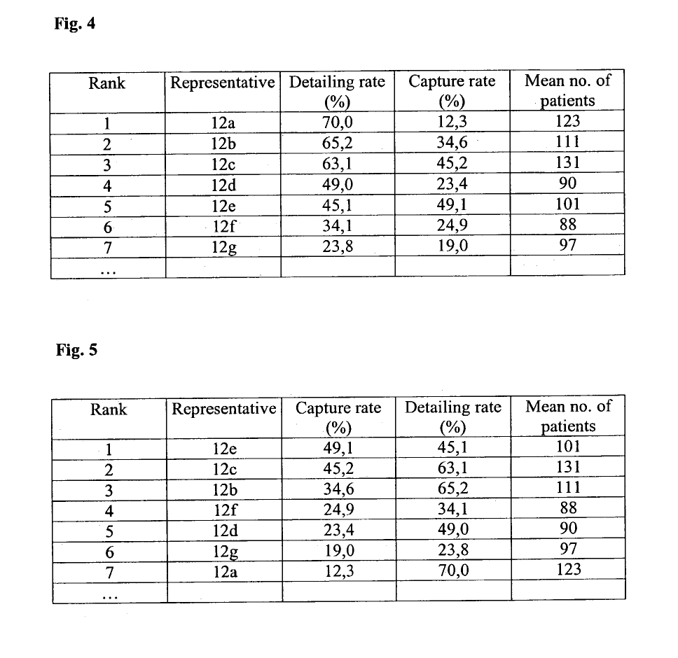

After collecting the relevant information regarding all representatives, i.e., not just the representatives 12a, 12b, 12c, 12d, 12e, 12f and 12g in a first sub-region 11a but all representatives 12 indicated in FIG. 3, the information stored and processed in the central computer unit 6 in the form of tables. This is shown in FIGS. 4 and 5. More precisely, FIG. 4 shows in the form of a table the performance of a number of representatives 12 according to detailing rate. Also, FIG. 5 shows in the form of a table the performance according to capture rate.

For reasons of simplicity, only information relating to the representatives in the first sub-region 11a are indicated in the tables in FIGS. 4 and 5. Obviously, information regarding all the representatives 12 shown in FIG. 3 should be included when preparing complete tables.

Also, information regarding the mean number of patients for each representative can also be determined and stored.

Furthermore, the perceived detailed message can also be registered, i.e., the interviewed physicians may state any comments regarding the detailing of the drug in question, for example “the drug has no side-effects,” “the drug has good efficacy,” “the drug does not lead to any weight gain” and similar statements.

Furthermore, as shown in FIGS. 4 and 5, respectively, the information regarding the representatives 12 can be ranked according to detailing rate or capture rate.

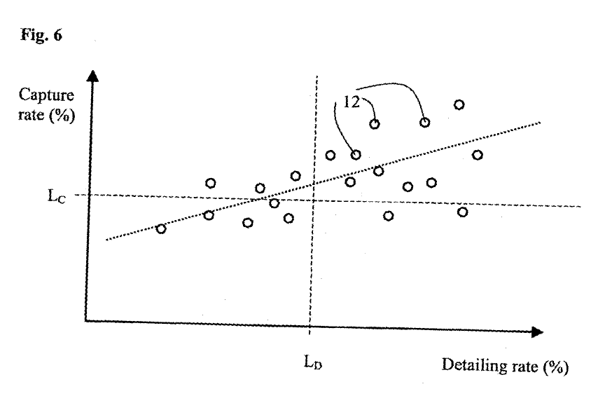

The information can also be displayed in the form of a diagram, as shown in FIG. 6. In this diagram, information related to the detailing rate and capture rate of all the representatives 12 in the region 10 is indicated. Also, a predetermined limit value L_{D} as regards the detailing rate is indicated in FIG. 6. The limit value L_{D} can be in the form of the average value of the detailing rate of all the representatives 12. Alternatively, some other type of threshold value can be indicated in the diagram. It can then be assumed that the representatives which achieve a detailing rate above said limit value L_{D} are considered to be acceptable. On the other hand, if certain representatives achieve a detailing rate which is lower than the limit value L_{D}, it can be assumed that improvements should be made.

A further limit value L_{C} can also be defined as regards the capture rate. In a manner which is analog to the detailing rate, the limit value L_{C} for the capture rate can be in the form of the average value of the capture rate of each representative 12. Alternatively, other type threshold values can be used in the diagram. It can then be determined that representatives should achieve a capture rate above said limit value L_{C}. On the other hand, if certain representatives achieve a detailing rate which is lower than the limit value L_{D}, it can be assumed that improvements should be made.

All the points indicated in the diagram of FIG. 6 together form a relationship which can be approximated by means of a curve 13 (shown by a dotted line). The relationship defined by the curve 13 can be expressed by the following equation:

y=k1+k2x

where y indicates the capture rate, x indicates the detailing rate, k1 is a constant which indicates the capture rate when the detailing rate is zero, and k2 is a constant which determines the inclination of the curve 13.

Furthermore, it should be noted that not only information relating to the representatives in the first sub-region 11a are indicated in the curve in FIG. 6, Obviously, information regarding all the representatives 12 shown in FIG. 3 should be included in such a curve 13.

Additional types of information can be used when presenting and evaluating the sales performance of the representatives. For example, the number of visits (or any other detailing activity) of a particular representative to each physician can be stored. Also, a relationship (for each representative) between the number of detailing visits and the detailing rate and/or the capture rate can be determined and stored. In this manner, the number of visits to each physician can be optimized.

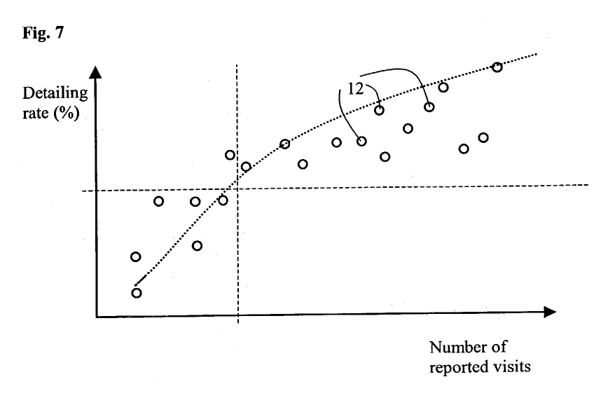

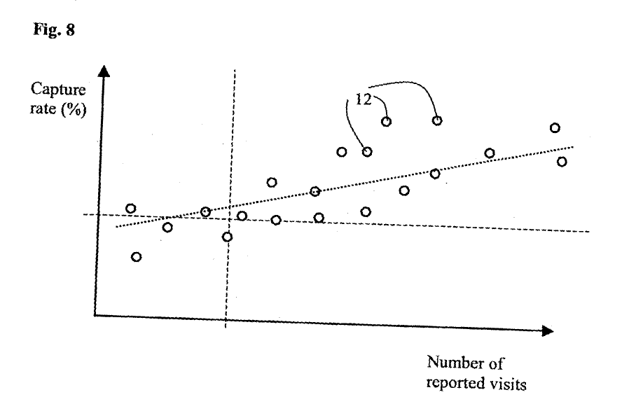

The impact of visits is indicated in FIG. 7, which shows the relationsship between the number of visits and the detailing rate for a number of representatives. In FIG. 7, limit values for the number of visits and the detailing rate (for example in the form of average values for these parameters) are shown by means of broken lines. Furthermore, FIG. 8 shows the relationsship between the number of visits and the capture rate. In FIG. 8, limit values for the number of visits and the capture rate (for example in the form of average values for these parameters) are also shown by means of broken lines. Due to the fact that the representatives report the number of visits to the information systems of the company in question, the capture rate and the detailing rate can be used in order to determine the relationship between the number of visits and the market performance.

The information presented can be divided according to geographical zones, or according to any other local or regional variations.

Furthermore, the sales performance over time can be stored and presented in order to obtain information on improvements or deteriorations of the sales performance can be detected.

Also, the representatives can be divided into groups, so that the relevant information can be presented and evaluated group by group.

Furthermore, any recalled detailing messages as perceived by the physicians at each detailing visits can also be stored, for later presentation and evaluation.

The invention relies on the fact that information is collected from a sample of decision-makers. The information is processed and reduced into the above-mentioned forms of presentation. A client may then obtain the finished result, i.e., the information regarding the sales performance described above, in various ways. For example, the results can be obtained by the client via a connection to the service provider's web page, by means of a password giving access to the information in question. This has been described above with reference to FIG. 2. In this manner, each client can select their own sets of information related to the drugs of interest. By connecting to the database 7 (see FIG. 2), the client may consequently select and use the set of information which is of interest, for providing tables, graphs etc., as shown in FIGS. 4, 5 and 6. Alternatively, the result can be delivered to the client on a suitable computer-readable data carrier, for example a diskette or a CD-ROM disc, which then contains the information selected by the user and processed according to the invention. The information can also be supplied via e-mail as a data file. Also, the result can be presented in the form of a printed publication.

The client can be a medicine manufacturer, a research center or even an advertising agency, who then may use the principles according to the invention in order to gain access to valuable information regarding its sales organization and its efficiency. In particular, the information which can be provided by means of the invention can be used for benchmarking, for example on different markets or during specific time periods.

The invention is not limited to the embodiments described above but may be varied within the scope of the appended patent claims. In particular, it should be noted that the invention is not limited for applying to marketing and selling medical drugs. The invention can be equally well used in other fields of trade, and other types of products (for example cars) and services (for example bank services).

1. A method for evaluating sales performance regarding at least one first product, comprising:
storing, in a central database, data related to the identities of a plurality of marketing representatives being associated with said product;
storing, in said database, collected data related to at least one key success factor associated with the market performance related to said product as a result of marketing activities of said plurality of marketing representatives with respect to a number of customers of said product; and
transmitting and presenting said information to at least one external user.

2. A method according to claim 1, comprising storing collected data related to at least one of the following measures:
a measure of the number of new customers purchasing said first product,
a measure of the number of customers switching between said first product and at least one additional, related product, and
a measure of the number of customers using said first product in addition to at least one additional, related product.

3. A method according to claim 1 or 2, comprising collecting data related to a key success factor corresponding to a measure of a proportion of said customers recalling personal promotion during a particular time period and related to said product.

4. A method according to claims 1 or 2, wherein said information is transmitted to said external user via a network such as the Internet.

5. A computer system for evaluating sales performance regarding at least one first product, comprising a database for storing collected data related to the identities of a plurality of marketing representatives being associated with said product and for storing collected data related to at least one key success factor associated with the market performance related to said product as a result of marketing activities of said plurality of marketing representatives with respect to a number of customers of said product; and a central computer unit adapted for transmitting and said information to at least one external user.

6. A system according to claim 5, wherein the central computer unit and the database are adapted for processing information related to said key success factor in the form of at least one of the following measures:
a measure of the number of new customers purchasing said first product,
a measure of the number of customers switching between said first product and at least one additional, related product, and
a measure of the number of customers using said first product in addition to at least one additional, related product.

7. A system according to claim 5 or 6, wherein said central computer unit and said database are connected to a network such as the Internet, the information in said database being accessible to said external user.

8. A method for facilitating and improving marketing activities and increasing sales of at least one first product by evaluating the sales performance of a plurality of marketing representatives of a company associated with said product, comprising:
collecting and storing data related to the identities of said marketing representatives;
collecting and storing data related to at least one key success factor associated with the market performance related to said product as a result of marketing activities of said plurality of marketing representatives with respect to a number of customers of said product; and
making said information available to at least one external user.

9. A method according to claim 8, wherein the key success factor associated with the market performance is constituted by information related to at least one of the following measures:
a measure of the number of new customers purchasing said first product,
a measure of the number of customers switching between said first product and at least one additional, related product, and
a measure of the number of customers using said first product in addition to at least one additional, related product.

10. A method according to claim 8 or 9, comprising collecting data related to an additional key success factor corresponding to a measure of a proportion of customers recalling personal promotion during a particular time period and related to said first product.

11. A method according to any one of claims 8-9, wherein said information is transmitted to said user via a network such as the Internet.

12. Computer-readable data carrier for storing information related to the evaluation of the sales performance of a plurality of marketing representatives of a company associated with at least one first product, said information being related to the identities of said marketing representatives and to at least one key success factor associated with the market performance related to said product as a result of marketing activities of said plurality of marketing representatives with respect to a number of customers of said product.
